(19) United States
(12) Patent Application Publication
(10) Pub. No.: US 2016/0265523 A1
(43) Pub. Date: Sep. 15, 2016

(54) ELECTRIC COMPRESSOR

(71) Applicant: KABUSHIKI KAISHA TOYOTA JIDOSHOKKI, Aichi-ken (JP)

(72) Inventors: Yusuke KINOSHITA, Aichi-ken (JP); Ken SUITOU, Aichi-ken (JP); Tatsuya KOIDE, Aichi-ken (JP); Junya YANO, Aichi-ken (JP)

(73) Assignee: KABUSHIKI KAISHA TOYOTA JIDOSHOKKI, Aichi-ken (JP)

(21) Appl. No.: 15/062,463

(22) Filed: Mar. 7, 2016

(30) Foreign Application Priority Data
Mar. 9, 2015 (JP) 2015-045749

(51) Int. Cl. F04B 39/12; H02K 11/33; F04C 29/00; F04B 35/04; F04C 18/344; F04C 18/02

(52) U.S. Cl. CPC F04B 39/12; F04C 18/344; F04C 18/0215; F04C 29/0085; F04B 35/04; H02K 11/33

(57) ABSTRACT

An electric compressor includes a compression mechanism for compressing a fluid, an electric motor for driving the compression mechanism, an inverter for driving the electric motor, a housing for housing the compression mechanism and the electric motor, a cover attached to the housing to house the inverter between the cover and the housing, and an impact-resistant member attached to the housing. The impact-resistant member includes a projecting portion arranged at a position spaced from the cover and the housing, and a spacer portion extending from the projecting portion toward the housing. The spacer portion is bonded to the housing to straddle an outer periphery of the cover. The impact-resistant member is attached to the housing by bonding the spacer portion to the housing.

This nonprovisional application is based on Japanese Patent Application No. 2015-045749 filed on Mar. 9, 2015 with the Japan Patent Office, the entire contents of which are hereby incorporated by reference.

### BACKGROUND OF THE INVENTION

1. Field of the Invention

The present invention relates to an electric compressor, and in particular to an electric compressor mounted on a vehicle.

2. Description of the Background Art

Japanese Patent Laid-Open No. 2014-9626 is a prior art document which discloses a configuration of an electric compressor. The electric compressor described in Japanese Patent Laid-Open No. 2014-9626 includes a compression mechanism for compressing a fluid, an electric motor for driving the compression mechanism, an inverter for driving the electric motor, and a housing for housing the compression mechanism, the electric motor, and the inverter. A cover for protecting the housing from an external force due to a collision is fixed to the outside of the housing. The cover is arranged with a gap being interposed between the cover and the housing, and the external force exerted on the cover is absorbed by the gap.

In the electric compressor described in Japanese Patent Laid-Open No. 2014-9626, only one side of the cover is supported. Accordingly, there is room for improving the impact resistance of the cover, and thus there is room for improving the impact resistance of the electric compressor.

### SUMMARY OF THE INVENTION

An electric compressor in accordance with the present invention includes a compression mechanism for compressing a fluid, an electric motor for driving the compression mechanism, an inverter for driving the electric motor, a housing for housing the compression mechanism and the electric motor, a cover attached to the housing to house the inverter between the cover and the housing, and an impact-resistant member attached to the housing. The impact-resistant member includes a projecting portion arranged at a position spaced from the cover and the housing, and a spacer portion extending from the projecting portion toward the housing. The spacer portion is bonded to the housing to straddle an outer periphery of the cover. The impact-resistant member is attached to the housing by bonding the spacer portion to the housing.

According to the present invention, the impact resistance of the electric compressor can be improved.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a side view showing an appearance of an electric compressor in accordance with a first embodiment of the present invention.

FIG. 2 is a front view showing the appearance of the electric compressor in accordance with the first embodiment of the present invention, viewed from a direction indicated by an arrow II in FIG. 1.

FIG. 3 is a perspective view of an impact-resistant member of the electric compressor in accordance with the first embodiment of the present invention, viewed from a back surface side.

FIG. 4 is a side view showing an appearance of an electric compressor in accordance with a second embodiment of the present invention.

FIG. 5 is a front view showing the appearance of the electric compressor in accordance with the second embodiment of the present invention, viewed from a direction indicated by an arrow V in FIG. 4.

FIG. 6 is a perspective view of an impact-resistant member of the electric compressor in accordance with the second embodiment of the present invention, viewed from a back surface side.

### DESCRIPTION OF THE PREFERRED EMBODIMENTS

Hereinafter, an electric compressor in accordance with each embodiment of the present invention will be described with reference to the drawings. In the description below, identical or corresponding parts in the drawings will be designated by the same reference numerals, and the description thereof will not be repeated.

### First Embodiment

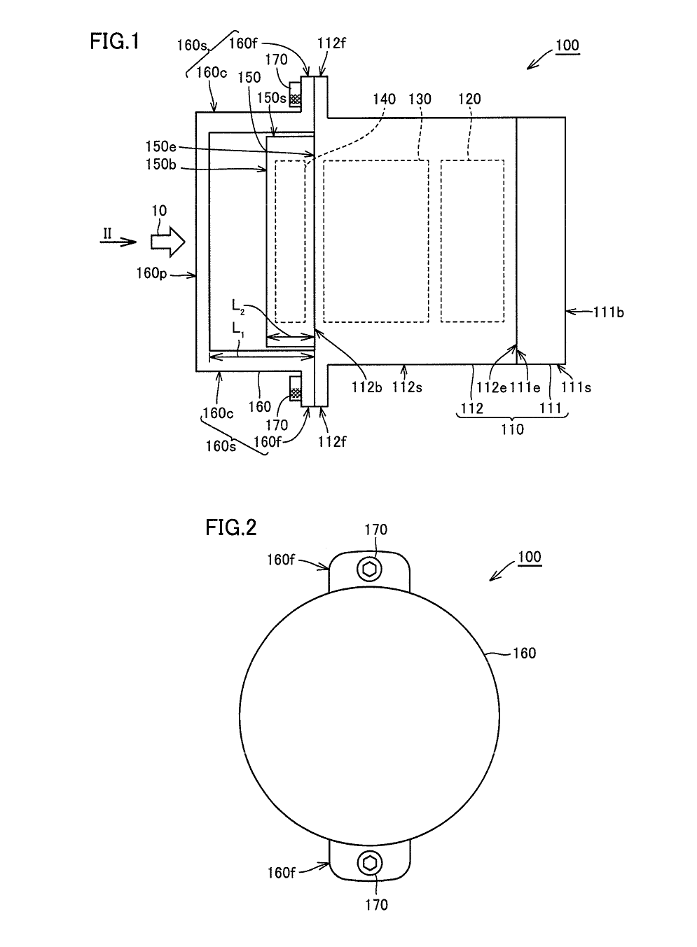

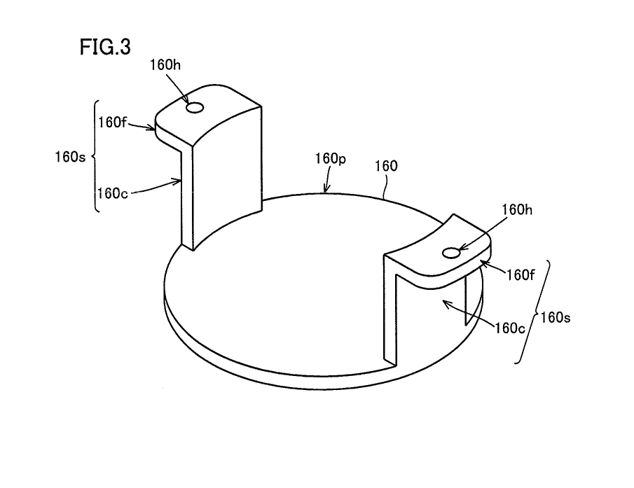

FIG. 1 is a side view showing an appearance of an electric compressor in accordance with a first embodiment of the present invention. FIG. 2 is a front view showing the appearance of the electric compressor in accordance with the first embodiment of the present invention, viewed from a direction indicated by an arrow II in FIG. 1. FIG. 3 is a perspective view of an impact-resistant member of the electric compressor in accordance with the first embodiment of the present invention, viewed from a back surface side.

As shown in FIGS. 1 to 3, an electric compressor 100 in accordance with the first embodiment of the present invention includes a compression mechanism 120 for compressing a fluid, an electric motor 130 for driving the compression mechanism 120, an inverter 140 for driving the electric motor 130, a housing 110 for housing the compression mechanism 120 and the electric motor 130, a cover 150 attached to the housing 110 to house the inverter 140 between the cover 150 and the housing 110, and an impact-resistant member 160 attached to the housing 110.

The housing 110 includes a suction housing 112 in which a suction port (not shown) is formed, through which a refrigerant is suctioned from an external refrigerant circuit (not shown), a discharge housing 111 in which a discharge port (not shown) is formed, through which the refrigerant is discharged, and a flange portion 112f provided to the suction housing 112.

In the present embodiment, each of the suction housing 112 and the discharge housing 111 has a bottomed cylindrical shape, and is made of, for example, a metal material such as aluminum. The cover 150 has a bottomed cylindrical shape, and is made of, for example, a metal material such as aluminum. The suction housing 112 houses the compression mechanism 120 and the electric motor 130.

The compression mechanism 120 compresses the refrigerant suctioned through the suction port into the housing 110, and discharges the compressed refrigerant through the discharge port. It should be noted that, as a concrete configuration of the compression mechanism 120, any configuration such as a scroll type, a piston type, or a vane type may be adopted.

The electric motor 130 is an electric motor driven with three-phase alternating current (AC) power, and drives the compression mechanism 120 by rotating a movable scroll. The electric motor 130 includes a rotor (not shown) having a rotating shaft, and a stator (not shown) covering the periphery of the rotor. The rotating shaft of the rotor is connected to the movable scroll. The stator has a stator coil, and is fixed to the suction housing 112. It should be noted that the stator coil is a part on which high-voltage power acts.

Each of the suction housing 112, the discharge housing 111, and the cover 150 includes a bottom wall, and a peripheral wall standing from an outer peripheral edge of the bottom wall and having an annular shape. An axial direction of the suction housing 112 matches an axial direction of the rotating shaft of the rotor.

An end portion 112e of a peripheral wall 112s of the suction housing 112 opposite to a bottom wall 112b thereof is bonded to an end portion 111e of a peripheral wall 111s of the discharge housing 111 opposite to a bottom wall 111b thereof. An end portion 150e of a peripheral wall 150s of the cover 150 opposite to a bottom wall 150b thereof is bonded to an outer surface of the bottom wall 112b of the suction housing 112.

The cover 150 is bonded to the housing 110 by a fastening member, an adhesive, or the like. The inverter 140 for driving the electric motor 130 is housed in a housing chamber defined by the outer surface of the bottom wall 112b of the suction housing 112 and the cover 150.

It should be noted that the cover 150 may have any shape as long as a housing chamber for housing the inverter 140 can be defined by the cover 150 and the housing 110. For example, when a recessed portion for housing the inverter 140 is provided in the bottom wall 112b of the suction housing 112, the cover 150 may have a shape of a plate which covers the recessed portion.

The suction housing 112 is provided with a pair of flange portions 112f extending outward in a radial direction of the rotating shaft of the rotor. Each flange portion 112f is provided with a screw hole (not shown) extending in the axial direction of the rotating shaft of the rotor. Although the flange portion 112f is formed integrally with the suction housing 112 in the present embodiment, the flange portion 112f and the suction housing 112 may be formed separately.

In the present embodiment, the compression mechanism 120, the electric motor 130, and the inverter 140 are arranged in order of the compression mechanism 120, the electric motor 130, and the inverter 140, along the axial direction of the rotating shaft of the rotor.

The inverter 140 performs control of rotation of the electric motor 130, and supply of power to the electric motor 130. The inverter 140 converts direct current (DC) power into AC power. The inverter 140 is electrically connected to the electric motor 130 through a cluster block and an airtight terminal (not shown). Further, the inverter 140 is connected with a power supply cable for receiving power supply. The inverter 140, the cluster block, the airtight terminal, and the power supply cable are parts on which high-voltage power acts.

The impact-resistant member 160 protects the inverter 140 from an external force 10. The external force 10 is generated, for example, by a collision of a vehicle equipped with the electric compressor 100. The impact-resistant member 160 is made of a steel material. However, the material for the impact-resistant member 160 is not limited to a steel material, and may be another metal material.

The impact-resistant member 160 includes a projecting portion 160p arranged at a position spaced from the bottom wall 150b of the cover 150 and the housing 110 (the suction housing 112), and a pair of spacer portions 160s extending from the projecting portion 160p toward the housing 110.

In the present embodiment, each spacer portion 160s has a standing portion 160c and a flange portion 160f. Although the spacer portion 160s is formed integrally with the projecting portion 160p in the present embodiment, the spacer portion 160s may be formed separately from the projecting portion 160p.

In the present embodiment, the projecting portion 160p has a disk-like outer shape. The projecting portion 160p extends in the radial direction of the rotating shaft of the rotor. However, the shape of the projecting portion 160p is not limited to the above shape, and for example, a surface of the projecting portion 160p opposite to its surface facing the cover 150 may be a curved surface that is outwardly convex.

The spacer portion 160s is provided at a position of each of both ends of the projecting portion 160p in a radial direction of the projecting portion 160p. The standing portion 160c extends from the projecting portion 160p toward the housing 110 (the suction housing 112), and in the present embodiment, the standing portion 160c extends in the axial direction of the rotating shaft of the rotor.

It should be noted that, although the spacer portions 160s (the standing portions 160c) protrude from two positions in the projecting portion 160p in the present embodiment, the present embodiment is not limited thereto, and the spacer portions 160s may protrude from three or more positions in the projecting portion 160p, or a cylindrical standing portion may protrude from the projecting portion 160p.

The flange portion 160f extends from an end portion of the standing portion 160c opposite to an end portion thereof on a side of the projecting portion 160p in an extending direction of the standing portion 160c, in a direction intersecting with the extending direction of the standing portion 160c (in the present embodiment, in the radial direction of the rotating shaft of the rotor). The flange portion 160f is provided with a hole portion 160h penetrating in the axial direction of the rotating shaft of the rotor, at a position corresponding to the screw hole in the flange portion 112f.

With the flange portion 160f and the flange portion 112f being in contact with each other, a headed bolt 170 inserted through the hole portion 160h is screwed into the screw hole in the flange portion 112f, and thereby each flange portion 160f is bonded to the housing 110 (the suction housing 112). Thereby, the impact-resistant member 160 is attached to the housing 110 (the suction housing 112).

In a state where the impact-resistant member 160 is attached to the housing 110 (the suction housing 112), the spacer portions 160s are bonded to the housing 110 (the suction housing 112) to straddle an outer periphery of the cover 150. That is, the spacer portions 160s are bonded to the housing 110 such that the cover 150 is located on a linear imaginary line which connects two flange portions 160f bonded to the housing 110. In other words, the spacer portions 160s are bonded to the housing 110 such that the cover 150 is located in a region sandwiched between the spacer portions 160s facing each other.

It should be noted that the structure of the spacer portions 160s is not limited to the above structure, and the spacer portions 160s only have to be bonded to the housing 110 such that the cover 150 is located on an imaginary line which connects any two positions of a portion bonded to the housing 110.

Further, a length L₁ of the spacer portion 160s (a length in the extending direction of the standing portion 160c) is longer than a length L₂ of the cover 150 (a length of the cover 150 in a direction in which the peripheral wall 150s stands from the bottom wall 150b). Accordingly, a gap with a distance (L₁−L₂) is formed between the projecting portion 160p and the cover 150.

The gap between the projecting portion 160p and the cover 150 serves as a buffer region for preventing the external force 10 from acting on the cover 150 when the impact-resistant member 160 receives the external force 10. Therefore, the gap between the projecting portion 160p and the cover 150 is preferably large as much as possible within an acceptable range of a space for installing the electric compressor 100.

The electric compressor 100 in accordance with the present embodiment is arranged within the vehicle such that the external force 10 is highly likely to act on the projecting portion 160p from the axial direction of the rotating shaft of the rotor. When the external force 10 acts on the projecting portion 160p from the axial direction of the rotating shaft of the rotor, the external force 10 is transmitted to the housing 110 through the spacer portions 160s. Thus, the external force can be suppressed from acting on the cover 150, and the parts on which high-voltage power acts, such as the inverter 140, can be protected.

Even if the projecting portion 160p and the spacer portions 160s are broken by the external force 10 and the external force acts on the cover 150, energy required to break the projecting portion 160p and the spacer portions 160s is consumed, and thus the external force 10 acting on the cover 150 is reduced.

In particular, in the electric compressor 100 in accordance with the present embodiment, the projecting portion 160p and the spacer portions 160s share the external force 10 like a both-end supported beam, and thus the withstand load of the projecting portion 160p and the spacer portions 160s is increased. Since the energy required to break the projecting portion 160p and the spacer portions 160s is thereby increased, the external force 10 acting on the cover 150 can be significantly reduced, and the parts on which high-voltage power acts, such as the inverter 140, can be protected. Thus, the electric compressor 100 in accordance with the present embodiment has an improved impact resistance.

Further, in the electric compressor 100 in accordance with the present embodiment, the flange portions 160f of the impact-resistant member 160 and the flange portions 112f of the housing 110 extend in a direction intersecting with a direction in which the external force 10 acts (in the present embodiment, the axial direction of the rotating shaft of the rotor). Thereby, when the external force 10 acts on the projecting portion 160p from the axial direction of the rotating shaft of the rotor, the external force 10 can be further transmitted to the housing 110, as compared with a configuration having no flange portion 160f.

Since the electric compressor 100 in accordance with the present embodiment is not configured such that a cylindrical standing portion protrudes from the projecting portion 160p and covers the entire outer periphery of the cover 150, the power supply cable to be connected to the inverter can be easily routed. Further, heat transmitted from the inverter 140 to the cover 150 can be efficiently cooled down.

Furthermore, since the electric compressor 100 in accordance with the present embodiment is configured to be provided with the impact-resistant member 160 separately from the cover 150, versatility of the electric compressor 100 can be enhanced. Specifically, when an impact-resistant cover whose strength is enhanced by setting the thickness of the cover to be thicker than usual or by forming the cover using a steel material is prepared without providing an impact-resistant member, in a vehicle in which the electric compressor is arranged at a position where it is less likely to receive the external force, there is no need to protect the inverter 140 from the external force, and thus a usual thin aluminum cover is used to reduce the weight of the electric compressor 100. Accordingly, covers of different specifications are used, reducing the versatility of the electric compressor. By providing the impact-resistant member 160 separately from the cover 150, it is only necessary to prepare the electric compressor 100 including the usual cover 150 as a standard, and thus the versatility of the electric compressor 100 can be enhanced.

It should be noted that, although the compression mechanism 120, the electric motor 130, and the inverter 140 are arranged along the axial direction of the rotating shaft of the rotor in the electric compressor 100 in accordance with the present embodiment, the arrangement of the inverter 140 is not limited thereto, and for example, the inverter 140 may be arranged outside the peripheral wall of the suction housing 112.

When the inverter 140 is arranged outside the peripheral wall of the suction housing 112, the end portion 150e of the peripheral wall 150s of the cover 150 opposite to the bottom wall 150b thereof is bonded to an outer surface of the peripheral wall 112s of the suction housing 112. The inverter 140 is housed in a housing chamber defined by the outer surface of the peripheral wall 112s of the suction housing 112 and the cover 150. In this state, in the impact-resistant member 160, each of the projecting portion 160p and the flange portions 160f extends in the axial direction of the rotating shaft of the rotor, and the standing portions 160c extend in a direction intersecting with the axial direction of the rotating shaft of the rotor (the radial direction of the rotating shaft of the rotor).

Further, the suction housing 112 does not necessarily have to be provided with the flange portions 112f. When the suction housing 112 is not provided with the flange portions 112f, the flange portions 160f of the spacer portions 160s are bonded to a surface of the bottom wall 112b of the suction housing 112 facing the projecting portion 160p.

Furthermore, a rib connected with the peripheral wall 112s may be provided on a side of each flange portion 112f of the suction housing 112 opposite to the bottom wall 112b. In this case, the strength of the flange portions 112f is increased, and thus the impact resistance of the electric compressor 100 is improved.

Hereinafter, an electric compressor in accordance with a second embodiment of the present invention will be described. It should be noted that an electric compressor 200 in accordance with the present embodiment is different from the electric compressor 100 in accordance with the first embodiment mainly in the shape of each of the housing and the impact-resistant member. Accordingly, in the description of the electric compressor 200 in accordance with the second embodiment, only the differences from the electric compressor 100 in accordance with the first embodiment will be described. Components identical to those of the electric compressor 100 in accordance with the first embodiment will be designated by the same reference numerals, and the detailed description of the components will not be repeated.

### Second Embodiment

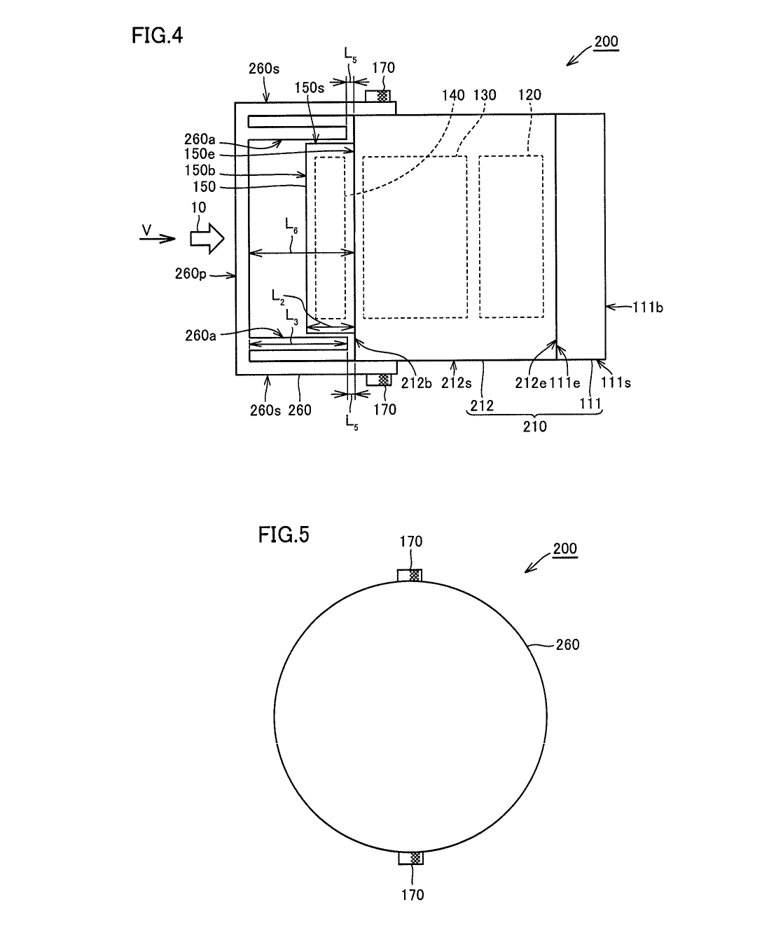

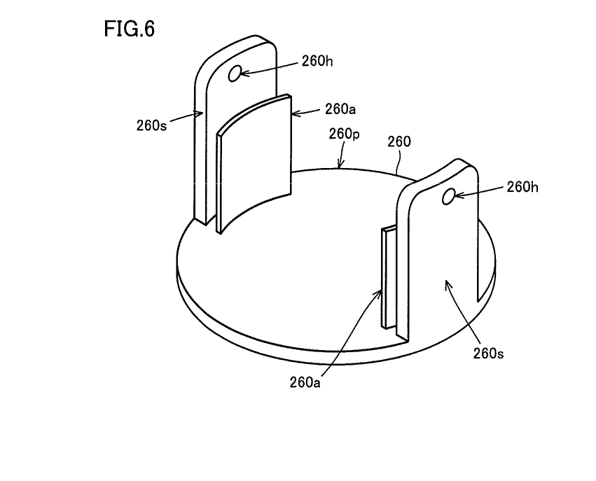

FIG. 4 is a side view showing an appearance of an electric compressor in accordance with a second embodiment of the present invention. FIG. 5 is a front view showing the appearance of the electric compressor in accordance with the second embodiment of the present invention, viewed from a direction indicated by an arrow V in FIG. 4. FIG. 6 is a perspective view of an impact-resistant member of the electric compressor in accordance with the second embodiment of the present invention, viewed from a back surface side.

As shown in FIG. 4, a housing 210 included in the electric compressor 200 in accordance with the second embodiment of the present invention is different from the housing 110 in the first embodiment in that a suction housing 212 is provided with screw holes (not shown) extending in the radial direction of the rotating shaft of the rotor, and is not provided with the flange portions 112f.

As shown in FIGS. 4 to 6, an impact-resistant member 260 included in the electric compressor 200 in accordance with the second embodiment of the present invention is different from the impact-resistant member 160 in the first embodiment in the shape of a pair of spacer portions 260s and in having a pair of support portions 260a. The impact-resistant member 260 includes a projecting portion 260p, the pair of spacer portions 260s, and the pair of support portions 260a. It should be noted that the pair of support portions 260a do not necessarily have to be provided.

Each spacer portion 260s has the same outer shape as that of the standing portion 160c in first embodiment. Further, the spacer portion 260s is provided at a position of each of both ends of the projecting portion 260p in a radial direction of the projecting portion 260p, as with the standing portion 160c in the first embodiment. The spacer portion 260s extends toward the housing 210 (the suction housing 212), and in the present embodiment, the spacer portion 260s extends in the axial direction of the rotating shaft of the rotor.

It should be noted that, although the spacer portions 260s protrude from two positions in the projecting portion 260p in the present embodiment, the present embodiment is not limited thereto, and the spacer portions 260s may protrude from three or more positions in the projecting portion 260p, or a cylindrical spacer portion may protrude from the projecting portion 260p. Although each spacer portion 260s is formed integrally with the projecting portion 260p in the present embodiment, the spacer portion 260s may be formed separately from the projecting portion 260p.

The spacer portion 260s is provided with a hole portion 260h penetrating in the direction intersecting with the axial direction of the rotating shaft of the rotor, at an end portion of the spacer portion 260s opposite to its end portion on a side of the projecting portion 260p in an extending direction of the spacer portion 260s.

With the spacer portion 260s being in contact with an outer peripheral surface of the suction housing 212, the headed bolt 170 inserted through the hole portion 260h is screwed into the screw hole in the suction housing 212, and thereby the spacer portion 260s is bonded to the housing 210 (the suction housing 212). Thereby, the impact-resistant member 260 is attached to the housing 210.

In a state where the impact-resistant member 260 is attached to the housing 210 (the suction housing 212), the spacer portions 260s are bonded to the housing 210 (the suction housing 212) to straddle the outer periphery of the cover 150. That is, the spacer portions 260s are bonded to the housing 210 such that the cover 150 is located in a region sandwiched between the spacer portions 260s facing each other.

Each support portion 260a is placed in the projecting portion 260p, and in the present embodiment, each support portion 260a is placed along the spacer portion 260s, at a position inside the spacer portion 260s in the radial direction of the projecting portion 260p. The support portion 260a extends from the projecting portion 260p toward the housing 210 (the suction housing 212), and in the present embodiment, the support portion 260a extends in the axial direction of the rotating shaft of the rotor. The length of the support portion 260a in an extending direction thereof is L₃.

When the impact-resistant member 260 is attached to the housing 210, an end portion of the support portion 260a opposite to an end portion thereof on a side of the projecting portion 260p in the extending direction of the support portion 260a (hereinafter referred to as a tip of the support portion 260a) is not in contact with the housing 210, and is spaced from the housing 210. Specifically, a gap with a distance L₅ is formed between the tip of the support portion 260a and a bottom wall 212b of the suction housing 212.

It should be noted that, although the support portions 260a protrude from two positions in the projecting portion 260p in the present embodiment, the present embodiment is not limited thereto, and the support portions 260a may protrude from three or more positions in the projecting portion 260p, or a cylindrical support portion may protrude from the projecting portion 260p. Although each support portion 260a is formed integrally with the projecting portion 260p in the present embodiment, the support portion 260a may be formed separately from the projecting portion 260p.

Further, in a state where the impact-resistant member 260 is attached to the housing 210 (the suction housing 212), a length L₆ from the projecting portion 260p to the bottom wall 212b of the suction housing 212 is longer than the length L₂ of the cover 150 (the length of the cover 150 in the direction in which the peripheral wall 150s stands from the bottom wall 150b). Accordingly, a gap with a distance (L₆−L₂) is formed between the projecting portion 260p and the cover 150. The distance (L₆−L₂) of the gap between the projecting portion 260p and the cover 150 is longer than the distance L₅ of the gap between the tip of each support portion 260a and the bottom wall 212b of the suction housing 212.

The electric compressor 200 in accordance with the present embodiment is arranged within the vehicle such that the external force 10 is highly likely to act on the projecting portion 260p from the axial direction of the rotating shaft of the rotor. When the external force 10 acts on the projecting portion 260p from the axial direction of the rotating shaft of the rotor, the external force 10 is transmitted to the housing 210 through the spacer portions 260s and the headed bolts 170. Thus, the external force can be suppressed from acting on the cover 150, and the parts on which high-voltage power acts, such as the inverter 140, can be protected.

Even if the projecting portion 260p and the spacer portions 260s are broken by the external force 10 and the external force acts on the cover 150, energy required to break the projecting portion 260p and the spacer portions 260s is consumed, and thus the external force 10 acting on the cover 150 is reduced.

Further, the impact-resistant member 260 in the present embodiment is provided with the support portions 260a. When the external force 10 acts on the projecting portion 260p from the axial direction of the rotating shaft of the rotor, the tips of the support portions 260a come into contact with the housing 210 before the projecting portion 260p comes into contact with the cover 150, and a portion of the external force 10 is transmitted to the housing 210 through the support portions 260a.

In this case, the projecting portion 260p comes into contact with the cover 150 after the support portions 260a are broken. Accordingly, even if the external force 10 acts on the cover 150, energy required to break the support portions 260a is consumed, and thus the external force 10 acting on the cover 150 is further reduced.

Further, when the impact-resistant member 260 is attached to the housing 210, such an inconvenience that the hole portion 260h cannot be aligned with the screw hole in the suction housing 212 due to a manufacturing error or the like does not occur, because there is a gap between the tip of each support portion 260a and the housing 210. As a result, the impact-resistant member 260 can be easily attached to the housing 210.

However, there may be no gap between the tip of each support portion 260a and the bottom wall 212b of the suction housing 212 when the impact-resistant member 260 is attached to the housing 210. That is, when the impact-resistant member 260 is attached to the housing 210, the tip of each support portion 260a may be in contact with the housing 210.

It should be noted that, although spacer portions 260s are bonded to the housing 210 (the suction housing 212) with being in contact with the outer peripheral surface of the suction housing 212 in the electric compressor 200 in accordance with the present embodiment, the structure of bonding the spacer portions 260s is not limited thereto. For example, tips of the spacer portions 260s may be bonded, using an adhesive or the like, to a surface of the bottom wall 212b of the suction housing 212 facing the projecting portion 260p.

Although the embodiments of the present invention have been described, it should be understood that the embodiments disclosed herein are illustrative and non-restrictive in every respect. The scope of the present invention is defined by the scope of the claims, and is intended to include any modifications within the scope and meaning equivalent to the scope of the claims.

What is claimed is:

1. An electric compressor, comprising:
a compression mechanism for compressing a fluid;
an electric motor for driving the compression mechanism;
an inverter for driving the electric motor;
a housing for housing the compression mechanism and the electric motor;
a cover attached to the housing to house the inverter between the cover and the housing; and
an impact-resistant member attached to the housing, wherein
the impact-resistant member includes a projecting portion arranged at a position spaced from the cover and the housing, and a spacer portion extending from the projecting portion toward the housing,
the spacer portion is bonded to the housing to straddle an outer periphery of the cover, and
the impact-resistant member is attached to the housing by bonding the spacer portion to the housing.

2. The electric compressor according to claim 1, wherein
the spacer portion has a standing portion extending from the projecting portion toward the housing, and a flange portion extending from an end portion of the standing portion opposite to an end portion thereof on a side of the projecting portion in an extending direction of the standing portion, in a direction intersecting with the extending direction of the standing portion, and
the flange portion is bonded to the housing.

3. The electric compressor according to claim 1, wherein
the impact-resistant member further has a support portion extending from the projecting portion toward the housing, and
an end portion of the support portion opposite to an end portion thereof on a side of the projecting portion in an extending direction of the support portion is spaced from the housing.
